(19) United States
(12) Patent Application Publication
(10) Pub. No.: US 2013/0147771 A1
(43) Pub. Date: Jun. 13, 2013

(54) METHOD FOR PREVENTION AGAINST REMISS TOUCH ON A TOUCHPAD

(71) Applicant: Elan Microelectronics Corporation, Hsinchu (TW)

(72) Inventors: Ying-Chieh CHUANG, Taipei City (TW); Jian-Wei CHEN, Taipei City (TW); Wen-Shu CHEN, Taoyuan City (TW); Wei-Wen YANG, New Taipei City (TW)

(73) Assignee: ELAN MICROELECTRONICS CORPORATION, Hsinchu (TW)

(21) Appl. No.: 13/669,919

(22) Filed: Nov. 6, 2012

(30) Foreign Application Priority Data
Dec. 7, 2011 (TW) 100145059

(51) Int. Cl. G06F 3/041

(52) U.S. Cl. 345/178

(57) ABSTRACT

A method for prevention against remiss touch on a touchpad includes dynamically adjusting the scope of an activating area on the touchpad according to a history record of operating the touchpad by the current user, so as to have the protection mechanism against remiss touch automatically adjusted to fit the current user.

### FIELD OF THE INVENTION

The present invention is related generally to a touchpad and, more particularly, to a method for prevention against remiss touch on a touchpad.

### BACKGROUND OF THE INVENTION

Typically, a touchpad is provided with prevention against remiss touch to avoid mis-operation when the touchpad is not to be operated. For example, referring to FIG. 1, when a touchpad 10 is not under operation, it is redefined to have two areas 12 and 14 thereon, of which only the central area 12 is set as an activating area, while the peripheral area 14 is set as an inactivating area because it tends to be unintentionally touched. In this case, any touch in the inactivating area 14 will be regarded as a remiss touch. However, this approach, which sets the activating area 12 to have a fixed scope, is inflexible and little adaptive to different users' operational requirements and thus, a solution with an adjustable activating area is developed, which allows the user to adjust the activating area 12 by adjusting four parameters up wide, down wide, left wide, and right wide, so as to customize the activating area 12 to have a desired scope according to the user's operational requirement. This art, even allowing users to have an adjustable activating area, requires users to manually set the remiss-touch rejected parameters for a desired activating area. Each time when a different user is to operate the touchpad 10 or when the user has changed his/her operational habit, for example, operational gestures or environments, the user has to set the inactivating area 14 again. In addition, the relative position between the touchpad 10 and a keyboard is also a factor that affects the incidence of remiss touch. Mechanical design differs machine by machine, and each user has individual palm size as well as operational habit, while the existing protection mechanism against remiss touch can not automatically adapt itself to different users. Therefore, each user has to manually adjust the remiss-touch rejected parameters each time to use a touchpad.

### SUMMARY OF THE INVENTION

An objective of the present invention is to provide a method for prevention against remiss touch on a touchpad.

Another objective of the present invention is to provide a method for automatically adjusting an activating area on a touchpad.

According to the present invention, a method for prevention against remiss touch on a touchpad includes dynamically adjusting the scope of an activating area on the touchpad according to a history record of operating the touchpad by the current user, so as to have the protection mechanism against remiss touch to be automatically adjusted to fit the current user.

Preferably, the method according to the present invention includes storing positions of effective touch points on the touchpad and keeping updating effective touch points, so as to adapt the activating area to the current user.

### BRIEF DESCRIPTION OF THE DRAWINGS

These and other objectives, features and advantages of the present invention will become apparent to those skilled in the art upon consideration of the following description of the preferred embodiments according to the present invention taken in conjunction with the accompanying drawings, in which:

FIG. 1 is an illustrative diagram of a conventional protection mechanism against remiss touch for a touchpad;

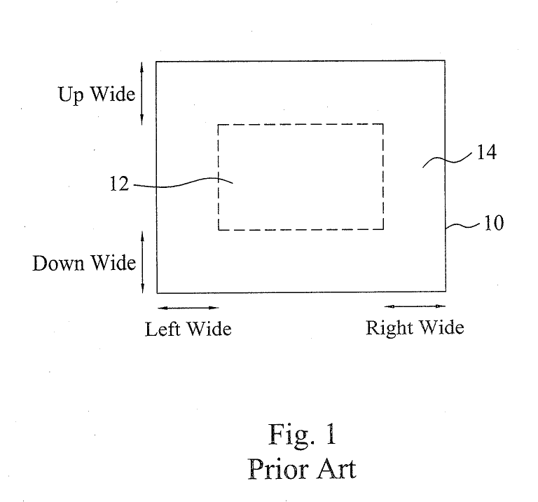

FIG. 2 is an illustrative diagram of a protection mechanism against remiss touch for a touchpad in a first embodiment according to the present invention;

FIG. 3 is schematic drawing showing a touchpad operated by a user;

FIG. 4 is a schematic drawing illustrating a flag F switched between two states;

FIG. 5 is a flowchart of implementing the protection mechanism against remiss touch shown in FIG. 2; and

FIG. 6 is an illustrative diagram of a protection mechanism against remiss touch for a touchpad in a second embodiment according to the present invention.

### DETAILED DESCRIPTION OF THE INVENTION

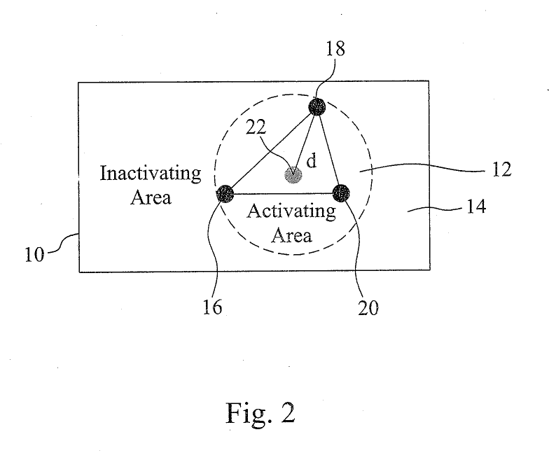

As a first embodiment according to the present invention, FIG. 2 illustrates a protection mechanism against remiss touch for a touchpad 10, which includes dynamically adjusting the scope of an activating area 12 on the touchpad 10 according to the history record of operating the touchpad 10 by the current user, and identifying the touches not in the activating area 12 as remiss touches. In other words, anywhere on the touchpad 10 except for the activating area 12 is set as an inactivating area 14. Since the scope of the activating area 12 is dynamically adjusted according to the history record of operating the touchpad 10 by the current user, the protection mechanism against remiss touch will automatically adjust itself to meet different users' requirements. Referring to FIG. 2, when the touchpad 10 is operated by a user, positions of the latest three effective touch points 16, 18, and 20 on the touchpad 10 are stored, the center-of-gravity position 22 of the three effective touch points 16, 18, and 20 is further determined, and then the center-of-gravity position 22 is taken as a center to define a circular region that could cover the three effective touch points 16, 18, and 20 as the activating area 12. For example, the maximum distance d between the center-of-gravity position 22 and the effective touch point 16, 18, or 20 is used as the radius for defining the circular region 12.

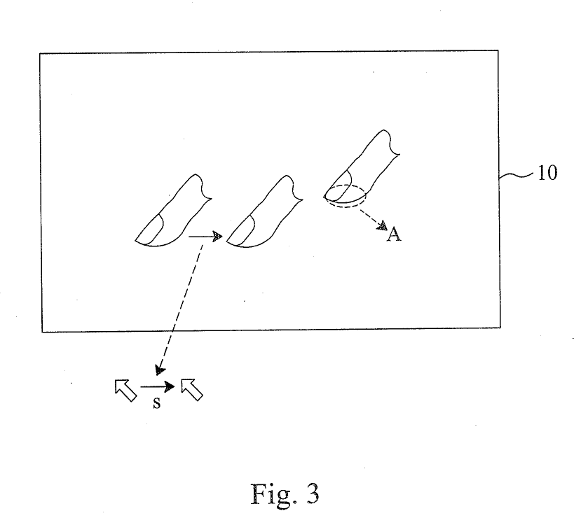

Various conditions may be used to select the effective touch points to define a better scope for the activating area 12. For example, referring to FIG. 3 for an embodiment, when a user operates the touchpad 10, the cursor displacement amount s caused by each touch on the touchpad 10 is compared to a preset threshold, and if the cursor displacement amount s is smaller than the preset value, the touch point of the touch is regarded as an ineffective touch point. In another embodiment, when a user operates the touchpad 10, the area A of each touch on the touchpad 10 is compared to a preset value, and if the area A is smaller than the preset value, the touch point of the touch is regarded as an ineffective touch point. In yet another embodiment, when a user operates the touchpad 10, the data volume of data accumulated during each touch staying on the touchpad 10 is compared to a preset range, and if the data volume is out of the preset range, the touch point of the touch is regarded as an ineffective touch point. These exemplary conditions may be used in combination for selecting the effective touch points.

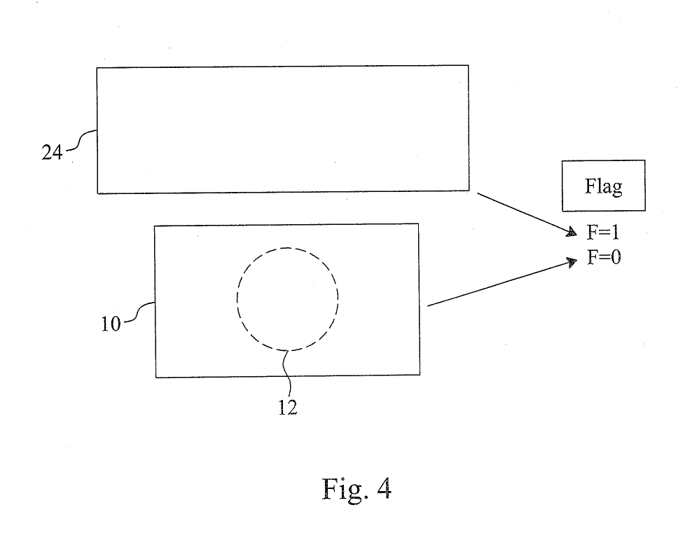

Preferably, a flag is used to indicate whether the touchpad 10 is under operation. For example, the flag in a first state indicates that the touchpad 10 is under operation, and the flag in a second state indicates that the touchpad 10 is not under operation. For example, referring to FIG. 4, a built-in function of a computer system for detecting whether a keyboard 24 is knocked is used to set a flag F. When the keyboard 24 is knocked, the flag F is set with 1, F=1. When the keyboard 24 has not been knocked for a time period, the flag F is switched to 0, F=0, or when the activating area 12 on the touchpad 10 is touched, the flag F is set with 0, F=0. By use of the flag F, it is ensured to store the history record of operating the touchpad 10 by the current user after the user stops typing on the keyboard 24. In addition, after the activating area 12 is adjusted, once the flag F has been switched from 0 to 1 and then switched from 1 to 0, it is to be identified whether the latest effective touch point is in the activating area 12. If so, the adjusted activating area 12 is dismissed and the activating area returns to the default of the touchpad 10, meaning that the whole area on the touchpad 10 including the areas 12 and 14 shown in the above embodiments is the activating area.

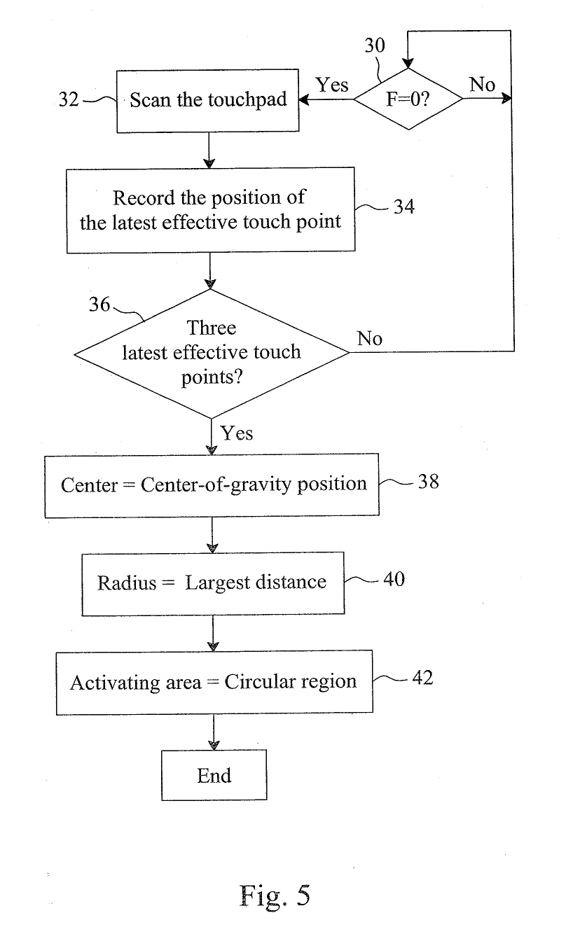

FIG. 5 is a flowchart of implementing the protection mechanism against remiss touch shown in FIG. 2. Step 30 reads out the value of the flag F. If F=0, the process goes to step 32 to scan the touchpad 10 to retrieve the history record of operating the touchpad 10 by the current user. If F=1, the process goes back to step 30. After step 32, step 34 records the position of the latest effective touch point on the touchpad 10, and then step 36 identifies whether three latest effective touch points have been collected already. If not, steps 30, 32, and 34 will be repeated until three latest effective touch points have been collected. After three latest effective touch points are collected, steps 38, 40, and 42 are performed to determine the scope of an activating area on the touchpad 10. Step 38 calculates the center-of-gravity position of the three latest effective touch points to be set as the center of a circular region. Step 40 calculates the distances from the center-of-gravity position to the three latest effective touch points, respectively, and selects the maximum one thereof as the radius of the circular region to be defined. Step 42 sets the circular region that is defined by the center and the radius previously determined by steps 38 and 40 as an activating area. After step 42, an activating area is defined. After the foregoing described process is finished, the process from step 30 to step 42 may be repeated once again or more times to adjust the scope of the activating area and dismiss the previously defined activating area, to have the scope of the activating area more fit the user's operational habit.

The above embodiments are illustrated by using the center-of-gravity of three latest effective touch points as a center to define a circular region as an activating area. In other embodiments, the scope of an activating area may be otherwise defined by using other mathematical approaches or topologies.

While the embodiment shown in FIG. 2 adopts three latest touch points for defining the scope of an activating area, in other embodiments, more or only two latest touch points may be used for defining the scope of an activating area.

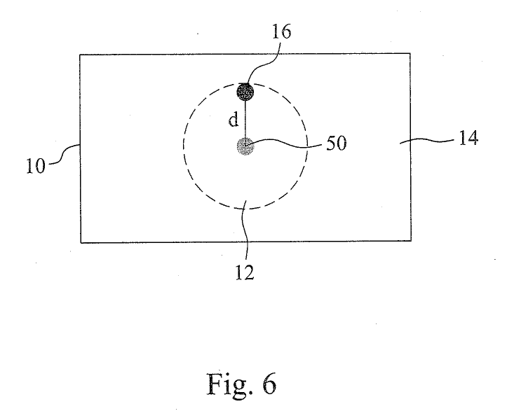

FIG. 6 illustrates an embodiment which provides a simpler approach for defining an activating area. A touchpad 10 has a preset point 50, for example, the center of the area on the touchpad 10. When a user operates the touchpad 10, the position of the latest effective touch point 16 is recorded. Then, the preset point 50 is taken as the center and the distance d between the preset point 50 and the effective touch point 16 is taken as the radius to define a circular region 12 as the activating area on the touchpad 10.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A method for prevention against remiss touch on a touchpad, comprising:
A.) dynamically adjusting a scope of an activating area on the touchpad according to a history record of operating the touchpad; and
B.) identifying a touch not in the activating area as a remiss touch.

2. The method of claim 1, wherein the step A comprises:
storing a position of a latest effective touch point on the touchpad when the touchpad is operated; and
defining a circular region, with a preset point as a center and a distance between the preset point and the latest effective touch point as a radius, as the activating area.

3. The method of claim 2, further comprising:
comparing a cursor displacement amount caused by a touch on the touchpad when the touchpad is operated to a preset value; and
identifying a touch point of the touch as an ineffective touch point if the cursor displacement amount is smaller than the preset value.

4. The method of claim 2, further comprising:
comparing an area of a touch on the touchpad when the touchpad is operated to a preset value; and
identifying a touch point of the touch as an ineffective touch point if the area is smaller than the preset value.

5. The method of claim 2, further comprising:
comparing a data volume of data accumulated during a touch staying on the touchpad when the touchpad is operated to a preset range; and
identifying a touch point of the touch as an ineffective touch point if the data volume is out of the preset range.

6. The method of claim 2, further comprising:
reading a flag to identify whether the flag is in a first state or a second state;
identifying the touchpad as under operation if the flag is in the first state; and
identifying the touchpad as not under operation if the flag is in the second state.

7. The method of claim 6, further comprising:
identifying whether the latest effective touch point is in the activating area if the flag has been switched from the first state to the second state and then switched from the second state to the first state after the activating area is adjusted; and
dismissing the adjusted activating area for returning the activating area to a default scope of the touchpad if the latest effective touch point is in the activating area.

8. The method of claim 1, wherein the step A comprises:
storing positions of three latest effective touch points on the touchpad when the touchpad is operated;
determining a center-of-gravity position of the three latest effective touch points; and
defining a circular region, with the center-of-gravity position as a center, that could cover the three latest effective touch points as the activating area.

9. The method of claim 8, further comprising:
comparing a cursor displacement amount caused by a touch on the touchpad when the touchpad is operated to a preset value; and
identifying a touch point of the touch as an ineffective touch point if the cursor displacement amount is smaller than the preset value.

10. The method of claim 8, further comprising:
comparing an area of a touch on the touchpad when the touchpad is operated to a preset value; and
identifying a touch point of the touch as an ineffective touch point if the area is smaller than the preset value.

11. The method of claim 8, further comprising:
comparing a data volume of data accumulated during a touch staying on the touchpad when the touchpad is operated to a preset range; and
identifying a touch point of the touch as an ineffective touch point if the data volume is out of the preset range.

12. The method of claim 8, further comprising:
reading a flag to identify whether the flag is in a first state or a second state;
identifying the touchpad as under operation if the flag is in the first state; and
identifying the touchpad as not under operation if the flag is in the second state.

13. The method of claim 12, further comprising:
identifying whether the latest effective touch point is in the activating area if the flag has been switched from the first state to the second state and then switched from the second state to the first state after the activating area is adjusted; and
dismissing the adjusted activating area for returning the activating area to a default scope of the touchpad if the latest effective touch point is in the activating area.

14. The method of claim 1, wherein the step A comprises:
storing positions of a plurality of latest effective touch points on the touchpad when the touchpad is operated;
determining a center-of-gravity position of the plurality of latest effective touch points; and
defining a circular region, with the center-of-gravity position as a center, that could cover the plurality of latest effective touch points as the activating area.

15. The method of claim 14, further comprising:
comparing a cursor displacement amount caused by a touch on the touchpad when the touchpad is operated to a preset value; and
identifying a touch point of the touch as an ineffective touch point if the cursor displacement amount is smaller than the preset value.

16. The method of claim 14, further comprising:
comparing an area of a touch on the touchpad when the touchpad is operated to a preset value; and
identifying a touch point of the touch as an ineffective touch point if the area is smaller than the preset value.

17. The method of claim 14, further comprising:
comparing a data volume of data accumulated during a touch staying on the touchpad when the touchpad is operated to a preset range; and
identifying a touch point of the touch as an ineffective touch point if the data volume is out of the preset range.

18. The method of claim 14, further comprising:
reading a flag to identify whether the flag is in a first state or a second state;
identifying the touchpad as under operation if the flag is in the first state; and
identifying the touchpad as not under operation if the flag is in the second state.

19. The method of claim 18, further comprising:
identifying whether the latest effective touch point is in the activating area if the flag has been switched from the first state to the second state and then switched from the second state to the first state after the activating area is adjusted; and
dismissing the adjusted activating area for returning the activating area to a default scope of the touchpad if the latest effective touch point is in the activating area.
